(19) United States
(12) Patent Application Publication
(10) Pub. No.: US 2025/0011598 A1
(43) Pub. Date: Jan. 9, 2025

(54) LIGNIN DISPERSIONS, CONCENTRATES, AND PRODUCTS THEREFROM

(71) Applicant: Lignoflow Technologies AB, Stockholm (SE)

(72) Inventors: Mika Sipponen, Bromma (SE); levgen Pylypchuk, Uppsala (SE)

(21) Appl. No.: 18/708,325

(22) PCT Filed: Nov. 18, 2022
(86) PCT No.: PCT/SE2022/051078

§ 371 Date: May 8, 2024

(30) Foreign Application Priority Data
Nov. 18, 2021 (SE) 2151406-2

(51) Int. Cl. C08L 97/00

(52) U.S. Cl. CPC C08L 97/005; C08L 2201/54

(57) ABSTRACT

The present disclosure relates to colloidal dispersions comprising lignin. The colloidal dispersions comprise a first lignin, a second lignin and an aqueous liquid continuous phase. The colloidal dispersion has a dispersion pH. The first lignin is a lignin that in absence of the second lignin would be essentially insoluble in the aqueous continuous phase at the dispersion pH. The second lignin is a lignin that in absence of the first lignin would be soluble in the aqueous continuous phase at the dispersion pH. The colloidal dispersion is a system in which colloidal lignin nanoparticles comprising the first lignin and the second lignin are dispersed in the aqueous liquid continuous phase. The present disclosure further relates to dispersible lignin concentrates obtainable from such dispersions, and lignin-containing products comprising such dispersions and concentrates.

### TECHNICAL FIELD

The present invention relates to colloidal dispersions comprising lignin, as well as dispersible lignin concentrates obtainable from such dispersions. The invention further relates to lignin-containing products comprising such dispersions and concentrates, as well as use of such dispersions and concentrates in the manufacture of lignin-containing products.

### BACKGROUND ART

Lignin is a renewable biopolymer derived from lignocellulose sources such as wood. Lignin is obtainable for example as a by-product from paper manufacturing, and a number of pulp mills isolate and market lignin on an industrial scale. Lignin therefore is a promising renewable material with proposed uses in a wide variety of applications.

Lignin isolated from sulfite pulping processes is known as lignosulfonate. Due to the presence of numerous low pKa sulfonate functionalities in lignosulfonate, such lignin is readily soluble in aqueous medium at relatively broad pH range and pH values exceeding the pKa. Commercial uses for lignosulfonate compositions include as plasticizer in concrete and as binder in road dust management applications. Due at least in part to the ready aqueous solubility of lignosulfonate, lignosulfonate accounts for the bulk of the commercial lignin market at present, despite sulfite pulping accounting only for a fraction (approximately one tenth) of chemical pulp production.

The Kraft process, otherwise known as sulfate pulping, is the predominant means of chemical pulp production. There are several known means of isolating lignin from spent kraft pulping (black) liquor, including the LignoBoost and LignoForce processes. Despite this, the present market for kraft lignin is much smaller than the lignosulfonate market. This may be due in part to the relative difficulty in handling and preparing compositions comprising kraft lignin, due to its insolubility in neutral aqueous media, excluding a few binary mixtures of water and organic solvents. Kraft lignin is typically soluble only in relatively strongly alkaline aqueous liquids.

A number of means have been proposed to facilitate the handling of kraft lignin by increasing its solubility. Such means may entail the use of unusual or expensive solvent mixtures, such as in Sosa et. al. (DOI: 10.1021/acssuschemeng.0c06655), where it is proposed that deep eutectic solvents may be used to dissolve and valorise lignin. Other means involve the chemical derivatisation of kraft lignin to provide a product more closely resembling lignosulfonate in structure and properties, as in patent application WO2021003561 A1.

There remains a need for an improved means of rendering lignin easier to handle.

### SUMMARY OF THE INVENTION

The inventors of the present invention have identified a number of shortcomings with regard to prior art means for simplifying the handling of lignins. Organic solvent-based methods may require the use of expensive solvents. Recycling the solvent would require solvent removal, which is energy-intensive and thus also expensive. Chemical derivatisation of lignin requires further process steps, reagents and/or solvents, and thus also significantly adds to the cost of lignin compositions. Moreover, the properties of the lignin may be significantly altered by the derivatisation, not necessarily always in a desired manner. Further common means for dispersing relatively insoluble components, such as comminution (milling) of solid particles, ultrasonication and aerosol processing also have associated drawbacks, primarily in terms of time-dependent solid/liquid phase separation and excessive cost.

It would be advantageous to achieve a means of overcoming, or at least alleviating, at least some of the above-mentioned drawbacks. In particular, it would be desirable to provide a lignin product that can utilize the most abundantly available lignins and is at the same time easier to handle and formulate.

To better address one or more of these concerns, a product having the features defined in the appended independent claim(s) is provided.

The product is a colloidal dispersion comprising a first lignin, a second lignin and an aqueous liquid continuous phase. The colloidal dispersion has a dispersion pH. The first lignin is a lignin that in absence of the second lignin would be essentially insoluble in the aqueous continuous phase at the dispersion pH, and the second lignin is a lignin that in absence of the first lignin would be soluble in the aqueous continuous phase at the dispersion pH. The colloidal dispersion is a system in which colloidal lignin nanoparticles comprising the first lignin and the second lignin are dispersed in the aqueous liquid continuous phase.

It has been found that such colloidal dispersions may be prepared, allowing stable dispersions having a high mass concentration of lignin to be obtained. Such dispersions significantly facilitate the handling and transport of lignin, as well as facilitating the formulation of lignin-containing products, since they can be formulated having a suitably non-alkaline pH, at more-or-less any desired concentration of lignin (up to very high concentrations), and without the presence of typically undesired components such as organic solvents.

According to another aspect of the invention, the objects of the invention are also achieved by a dispersible concentrate according to the appended claim(s). The dispersible concentrate is obtainable by dewatering of a colloidal dispersion as described herein and as defined in the appended independent claims. The dispersible concentrate is preferably dried to a total dry matter content of less than 95 wt %, such as to a total dry matter content of less than 90 wt %, such as to total dry matter content of less than 80 wt %.

Such a concentrate further facilitates the transport of lignin since it renders lignin in a very highly concentrated form. At the same time, the concentrate is readily re-dispersible in aqueous media, allowing for easy formulation directly from the concentrate when desired.

According to a further aspect of the invention, the objects of the invention are also achieved by a lignin-containing product according to the appended claims(s). The lignin-containing product comprises a colloidal dispersion and/or a dispersible concentrate as described herein and as defined in the appended claims.

Further objects, advantages and novel features of the present invention will become apparent to one skilled in the art from the following detailed description.

### BRIEF DESCRIPTION OF THE DRAWINGS

For a fuller understanding of the present invention and further objects and advantages of it, the detailed description set out below should be read together with the accompanying drawings, in which the same reference notations denote similar items in the various diagrams, and in which:

FIG. 1a is a graph schematically illustrating the optimal ratio of lignosulfonate (LS) to softwood kraft lignin (SKL) for colloidal lignin nanoparticle (LNP) stabilization at higher total lignin concentrations;

FIG. 1b is a graph schematically illustrating the optimal ratio of lignosulfonate (LS) to softwood kraft lignin (SKL) for colloidal lignin nanoparticle (LNP) stabilization at lower total lignin concentrations;

FIG. 2 is a graph schematically illustrating the size of LNPs as a function of SKL concentration in dispersion with LS (at LS to SKL ratio=4);

FIG. 3 is a series of images illustrating the properties of a LS/SKL gel sample having a lignin content before drying of approx. 15 wt. %, wherein image 1 is the gel pre-drying, image 2 is the post-dried gel and image 3 is a redispersed dispersion of the post-dried gel;

FIG. 4 is a graph illustrating the stability and particle size of Domsjö lignosulfonate (LS) and organosolv (OS) lignin dispersions at varying LS:OS ratios;

FIG. 5 is a graph illustrating the stability of Sigma-Aldrich lignosulfonate (LS) and organosolv (OS) lignin dispersions at varying LS:OS ratios; and

FIG. 6 is a graph illustrating the change of dynamic viscosity over time and thixotropic properties of a LS/SKL nanogel.

### DETAILED DESCRIPTION

### Dispersions

In the context of the present disclosure, a colloidal dispersion is a system in which colloidal lignin nanoparticles (LNP) comprising a first lignin and a second lignin are dispersed in an aqueous liquid continuous phase. By colloidal lignin nanoparticles, it is meant lignin particles having at least in one direction a dimension on a scale of approximately between 1 nm and 1 μm. For example, the present dispersions may comprise particles having a hydrodynamic diameter of less than about 500 nm, such as less than about 300 nm, such as less than about 200 nm. Such dispersions may also be termed stable dispersions, as the dispersions demonstrate no noticeable precipitation upon storage for an extended timescale (>1 week). The colloidal dispersions may also simply be referred to as dispersions herein. The aqueous liquid phase of the colloidal dispersions may be essentially free of dissolved lignin. For example, less than 5 wt % of total lignin may be dissolved in the aqueous liquid phase.

Depending on the concentration of the dispersion, the properties of the dispersions may range from free-flowing liquids at low lignin concentrations to gel-like consistency at higher lignin concentrations. Such gel-like dispersions are termed nanogels and these may have thixotropic (shear-thinning) properties. However, even the most concentrated of gel-like dispersions resist irreversible aggregation and may be readily diluted to provide free-flowing dispersions having particle sizes (hydrodynamic diameters) in the nanoscale range and good polydispersity. This is remarkable, since it is otherwise well-established in the art that lignin dispersions typically tend to aggregate and form solid precipitates/deposits at high concentration, elevated temperature, low pH and/or high salt concentration. See e.g. Sewring, T, PHD Thesis, 2019, Chalmers University of Technology; Lievonen, M. et al., Green Chem., 2016, 18, 1416-1422; Lintinen et al., Nordic Pulp & Paper Research Journal Vol 32 No 4, 2017.

### Lignin

Lignin is an amorphous polyphenolic material created through the enzymatic polymerisation of primarily p-coumaryl alcohol, coniferyl alcohol, and sinapyl alcohol in lignocellulosic materials such as wood. The lignins for use in the present invention may be obtained from any lignocellulosic source material. These include wood, grass, algae, annual crops and agricultural waste etc. Alternatively, one or more of the lignins may be synthetic lignins.

Suitable woods may include softwoods and hardwoods. The softwood tree species can be for example, but are not limited to: spruce, pine, fir, larch, cedar, and hemlock. Examples of hardwood species from which lignin suitable as a starting material in the present invention may be derived include, but are not limited to: birch, oak, poplar, beech, eucalyptus, acacia, maple, alder, aspen, gum trees and gmelina. The raw material for lignin production may comprise a mixture of different softwoods, e.g. pine and spruce. The raw material may also comprise a non-wood raw material, such as bamboo, sugar beet pulp, wheat straw, soy hulls, corn stover, bagasse and grasses such as switchgrass and elephant grass.

Since the lignins can be produced from various renewable resources, such as wood, agricultural residues and annual crops, they are thus abundant and biodegradable. By renewable it is meant a material derived from a natural resource that, after exploitation, can return to its previous stock levels by natural processes of growth or replenishment within a reasonable time scale.

The lignins used may be fractionated by any means known in the art, e.g. ultrafiltration or precipitation, in order to provide purer lignins or lignins with reduced dispersity.

The lignins may be used in their neutral form or derivatized form, for instance in form of salts, for example alkali metal salts, such as sodium salts.

The lignins may be isolated and provided in pulverized form for use in the compositions of the invention. Alternatively, the lignins of the present invention may comprise or consist of spent pulping liquor. For example, the first lignin may comprise or consist of spent liquor from a kraft or soda pulping process. The second lignin may comprise or consist of spent liquor from a sulfite pulping process. These spent liquors may be treated, partially treated, or untreated prior to use in the present invention, and may therefore comprise varying amounts of other byproducts from the pulping industry such as hemicelluloses, resin acids and tall oil.

### First Lignin

The first lignin is a lignin that, without the presence of the second lignin, would be essentially insoluble in the aqueous continuous phase at the pH of the dispersion. That is to say that the first lignin is a lignin that is essentially insoluble in acidic and neutral aqueous media, such as a lignin that is soluble only at a pH of greater than about 10. Such lignins typically may be isolated as by-products of an alkaline or neutral pulping process for the manufacture of paper or board. Common such pulping processes include, but are not limited to, the kraft (sulfate) process, soda process and organosolv processes. The first lignin may be obtained from a LignoBoost or LignoForce process whereby high-quality lignin is obtained by at least partially neutralising kraft black liquor using carbon dioxide in order to precipitate the lignin. The LignoBoost process is further described in: Tomani, Per; The Lignoboost Process; Cellulose Chem Technol., 44(1-3), 53-58 (2010).

The first lignin may be isolated as a by-product of cellulosic ethanol production. When fermenting a lignocellulosic biomass feedstock to produce ethanol, typically at least 15 to 30 percent of the biomass remains unconverted after fermentation. This residual biomass comprises primarily lignin and cellulose.

The first lignin used in the present invention is preferably non-derivatised lignin. By non-derivatised lignin it is meant lignin that is not subject to any derivatisation post-isolation. However, lignin may be subject to some degree of derivatisation (e.g. introduction of thiol groups during Kraft pulping), hydrolysis, fragmentation, repolymerization, or oxidation prior to or during isolation, depending on the process used for isolating the lignin, as a consequence of the production/isolation process. For example, lignins isolated by the kraft and soda pulping processes are considered to be non-derivatised if not subjected to any further derivatisation steps post-isolation.

The first lignin may be selected from kraft lignin, soda lignin, organosolv lignin and native lignin; salts of such lignins; as well as combinations of such lignins and/or their salts.

### Second Lignin

The second lignin is a lignin that, without the presence of the first lignin, would be soluble in the aqueous continuous phase at the pH of the dispersion. Such lignins may typically be derivatised with functional groups that render the lignin soluble, either during production/isolation or post-isolation. Such functional groups may be anionic groups such as sulfonate or carboxylate groups, or may be cationic groups such as quaternary ammonium groups. For example, lignosulfonate, which is isolated as a by-product of the sulfite pulping process, has an abundance of sulfonate groups formed on the lignin primary structure. Other lignins suitable for use as the second lignin may be obtained by derivatisation of non-soluble lignins in order to render them more soluble. For example, the second lignin may comprise a kraft, soda, organosolv or other lignin isolate that has been derivatised in order to provide an abundance of sulfonate, carboxylate, amine or quaternary ammonium groups on the lignin primary structure. Oxidation of lignin may also render it soluble. Suitable means of derivatising and/or oxidising lignins are known in the art.

The second lignin may be an anionic lignin, i.e. a lignin that is anionic at the dispersion pH. The anionic lignin may preferably be selected from lignosulfonate, sulfonate-derivatised lignin, carboxylate-derivatised lignin, lignin-polymer grafts, non-covalent lignin-polymer conjugates, and oxidized lignin; salts of such lignins; as well as combinations of such lignins and/or such salts.

The second lignin may be a cationic lignin, i.e. a lignin that is cationic at the dispersion pH. The cationic lignin may preferably be selected from a cationic primary amine, secondary amine, tertiary amine, and quaternary ammonium-derivatised lignin; salts of such lignins; as well as combinations of such lignins and/or such salts.

### Aqueous Continuous Phase

The dispersion medium that ultimately forms the aqueous continuous phase is an aqueous medium. By aqueous medium it is meant a liquid medium comprising primarily (by mass) of water. The aqueous medium may consist essentially only of water, or it may consist of an admixture of water with one or more further liquids, such as an organic solvent. If consisting of an admixture, the further liquid(s) is/are miscible or at least dispersible in water. The further liquid(s) may for example be a polar protic or aprotic organic solvent. By polar, it is meant a solvent having a dielectric constant & greater than 15. Suitable polar protic solvents include, but are not limited to, ethylene glycol, ethanol, methanol, n-propanol and isopropanol. Suitable polar aprotic solvents include, but are not limited to, dimethylformamide (DMF), acetonitrile (MeCN), dimethyl sulfoxide (DMSO), N-methyl-2-pyrrolidone (NMP) and propylene carbonate. The aqueous medium may comprise greater than 60 vol % water, greater than 80 vol % water, greater than 90 vol % water, or greater than 95 vol % water.

### Further Components

The dispersions of the invention may comprise further components known in the art, including but not limited to salts, hemicelluloses, resin acids, tall oil soaps, dyes, pigments, stabilizers, antioxidants, enzymes, curing initiators, flame retardants, surfactants and corrosion inhibitors. For example, the colloidal dispersion tolerates the presence of salts (e.g. 2 M sodium sulfate) with no observable aggregation.

### Composition

The upper concentration of lignin in the dispersion appears to be limited only by the aqueous solubility of the lignins used, and the lower concentration has no apparent boundary, although very dilute dispersions are typically undesirable from an economic viewpoint. The colloidal dispersion therefore may have a concentration of from about 0.1 to about 80 wt %, such as from about 3 wt % to about 60 wt %, such as from about 5 wt % to about 50 wt %, such as from about 10 wt % to about 40 wt %, calculated as the combined total weight of the first and second lignin relative to the total weight of the dispersion. It is observed that the hydrodynamic diameter of the colloidal lignin particles decreases as the total lignin concentration increases. This is opposite to the trend that is observed in the absence of the second lignin (e.g. lignosulfonate).

The optimal ratio of the second lignin to the first lignin in the composition may vary depending on the concentration of the composition. In concentrated dispersions, the optimal mass ratio of the second lignin to the first lignin may be from about 5:1 or greater. However, in more dilute dispersions, the optimum concentration may be lower, for example 4:1 or greater at a concentration of approx. 2 wt %. Dispersions having acceptable properties may be achieved having a mass ratio of the second lignin to the first lignin within a range of from about 1:90 to about 90:1, such as from about 2:1 to about 20:1, such as from about 3:1 to about 10:1, such as from about 4:1 to about 5:1. Note that the total present market availability of lignosulfonate to kraft lignin is at present approximately 5:1 (1 Mton/year lignosulfonate production and 0.2 Mton/year kraft lignin production), although the future market availability of kraft lignin could be expanded considerably. Thus, the range of acceptable ratios of second to first lignin tallies well with present and future market availability.

The pH of the dispersion (termed herein the dispersion pH) is a pH where the first lignin would normally be essentially insoluble in aqueous solution, i.e. have a solubility of less than 10 g/L at room temperature, such as slightly soluble, very slightly soluble, practically insoluble, or insoluble. For reference, the solubility of kraft lignin typically increases significantly at a pH of about 10, for example from a solubility of approx. 1.8 g/L at pH less than 9 to a solubility of approx. 100 g/L at a pH greater than 11 for a specific softwood kraft lignin (see Kong, Fangong, et al. “Water soluble kraft lignin-acrylic acid copolymer: Synthesis and characterization.” Green Chemistry 17.8 (2015): 4355-4366). The dispersion pH may be a pH of from about pH 1 to about pH 10, such as a dispersion pH of from about pH 3 to about pH 8, such as a dispersion pH of from about pH 5 to about pH 7.

### Production

The dispersions may be produced in any one of a variety of manners, each method essentially involving forming a mixture of the first and second lignin in an aqueous phase and adjusting the pH of this mixture if necessary to form the colloidal dispersion. The dispersions may be prepared at a temperature of from 10 to 100° C., preferably 0 to 50° C., even more preferably 10 to 30° C. It is known in the art that elevated temperatures may affect the stability of kraft lignin dispersions (Sewring, T. et al. “Acid Precipitation of Kraft Lignin from Aqueous Solutions: The Influence of pH, Temperature, and Xylan”, Journal of Wood Chemistry and Technology, 2019, 39(1), 1-13) as well as the hydrophobicity of lignosulfonate (Li, H. et al. “Effect of temperature on polyelectrolyte expansion of lignosulfonate,” BioRes., 2015, 10(1), 575-587). For these reasons, elevated temperatures are not preferred.

The first and second lignins may each be dissolved separately in a respective aqueous phase prior to mixing of the resulting solutions. In order to dissolve the first lignin it is required that the pH of the aqueous phase is sufficiently high to provide significant solubility, e.g. a pH>10 if the first lignin is a kraft lignin or soda lignin. The second lignin is typically soluble even at low pH. For example, lignosulfonates typically demonstrate good solubility over a broad pH range from acidic to alkaline, with aqueous solubility especially in acidic pH increasing with increasing degree of sulfonation, and carboxylated lignins demonstrate good solubility at pH greater than 4. If spent pulping liquids are utilized as the source of the first and/or second lignin, then the lignins may already be dissolved in aqueous medium, and the steps of dissolving the lignins may be omitted.

After dissolution, two separate lignin solutions may then be mixed in appropriate ratios in order to achieve the desired ratio of second to first lignin. The pH of this mixture may then optionally be adjusted to a pH where the dispersion is formed, if necessary. The dispersion is formed at a pH where the first lignin would normally be insoluble and precipitate from solution, e.g. a pH of about 10 or lower for kraft lignin. Adjustment of pH may be performed by adding acid to the mixture, e.g. dilute sulfuric acid. However, the solution of the second lignin may itself be acidic and the pH of the mixture may then be adjusted only due to addition of this second lignin solution to the alkaline first lignin solution. Therefore, adjustment of pH by addition of a separate acid may not always be necessary.

Alternatively, the first and second lignins both may respectively be dissolved in an aqueous phase having a pH at which the first lignin is soluble, e.g. a pH>10 if the first lignin is a kraft lignin. These steps may be performed sequentially in any order, or may be performed simultaneously by addition of the lignins separately or as a mixture to the aqueous phase. If performed sequentially, it may be preferable to dissolve the first lignin first, since dissolution of the second lignin may typically decrease the pH, and could render the first lignin insoluble. Once a mixture of the first and second lignins are formed, the dispersion may be produced by optional adjustment of pH as described above.

### Concentrate

In this manner, dispersions may be formed having a high concentration of lignin as described above. However, the dispersions may be dewatered using conventional means known in the art to provide a concentrate having an even higher dry matter content. Applicable means of dewatering include, but are not limited to, evaporation and membrane separation of excess water. Concentrates produced in this manner have been found to be redispersible in aqueous media provided that over-excessive water removal, such as complete water removal, is avoided. Without wishing to be bound by theory, it is thought that the dispersed lignin particles may have a micellar structure, and this micellar structure may be damaged or destroyed by excessive drying. It is though that as long as the micellar structure remains intact, the lignin particles will be redispersible. Thus, the dispersible concentrate may be obtainable by dewatering of a colloidal dispersion to a total dry matter content of less than 95 wt %, such as to a total dry matter content of less than 90 wt %, such as to total dry matter content of less than 80 wt %.

### Applications

The colloidal dispersions and dispersible concentrates as disclosed herein facilitate use of lignin and formulation of lignin products. The colloidal dispersions and dispersible concentrates may therefore be utilized in any of a number of applications where the use of lignin is already implemented or proposed. Such applications include, but are not limited to, use in paints and coatings, polymer composites, concrete plasticizers, agriculture (fertilizer and pesticide formulations), food and feed (dispersants, antioxidants, etc.), cosmetics (sunscreens; emulsifiers), water treatment (coagulants and adsorbents), and energy storage (porous carbons for electrodes).

The colloidal dispersions and dispersible concentrates may be used directly in formulating products for such applications, or the formulated products for such applications may comprise material deriving from the colloidal dispersions and dispersible concentrates as described herein. For example, the colloidal dispersions and dispersible concentrates may be partially or fully dewatered (e.g. total dry matter content greater than 95 wt %, such as 97%, 99% or 100%) prior to use. Alternatively, or in addition, the lignin of the colloidal dispersions and dispersible concentrates may be reacted by curing, copolymerisation or other derivatisation to form new lignin-derived materials.

The colloidal dispersions and dispersible concentrates may also find use in alternative methods for recycling or valorising spent pulping liquors. For example, the methods described herein for production of the colloidal dispersions could potentially replace existing LignoBoost and/or LignoForce processes, since to obtain value-added lignin products, some technical stages, e.g. lignin oxidation, solid-liquid separation, and washing, can be omitted or implemented in an alternative manner.

The colloidal lignin suspension containing 2 M sodium sulfate does not prevent fungal growth at 38° C., indicating it is non-toxic to microorganisms.

### EXAMPLES

The invention will now be described in more detail with reference to certain exemplifying embodiments and the drawings. However, the invention is not limited to the exemplifying embodiments discussed herein and/or shown in the drawings, but may be varied within the scope of the appended claims. Furthermore, the drawings shall not be considered drawn to scale as some features may be exaggerated in order to more clearly illustrate certain features.

Particle size of the particles were determined by dynamic light scattering (DLS) methods using a Zeta Sizer instrument (Malvern, UK). The measurements were performed for water-diluted dispersions at 25° C. without change in the dispersion pH.

Dynamic viscosities of lignin nanoparticle dispersions were measured using a rotational viscometer (Viscotech Myr VR 3000) with R2-R5 spindles using a method in accord with ASTM D2196-10. The shear rate was varied for extrapolation of zero-shear viscosity and determination of dynamic viscosities as a function of total lignin concentration and pH.

### Example 1

In the experiments of Example 1, softwood kraft lignin (BioPiva 100) from UPM Biochemicals is used as the first lignin and technical sodium lignosulfonate (DS10) from Domsjö Fabriker is used as the second lignin.

Dispersions of lignosulfonate (LS) and softwood kraft lignin (SKL) were produced by dissolving relevant quantities of the lignins in dilute base (1 M NaOH) and then adjusting the pH of the resulting mixture (using 1 M sulphuric acid) to provide a colloidal dispersion having a final pH somewhere in the range of from 2-8.

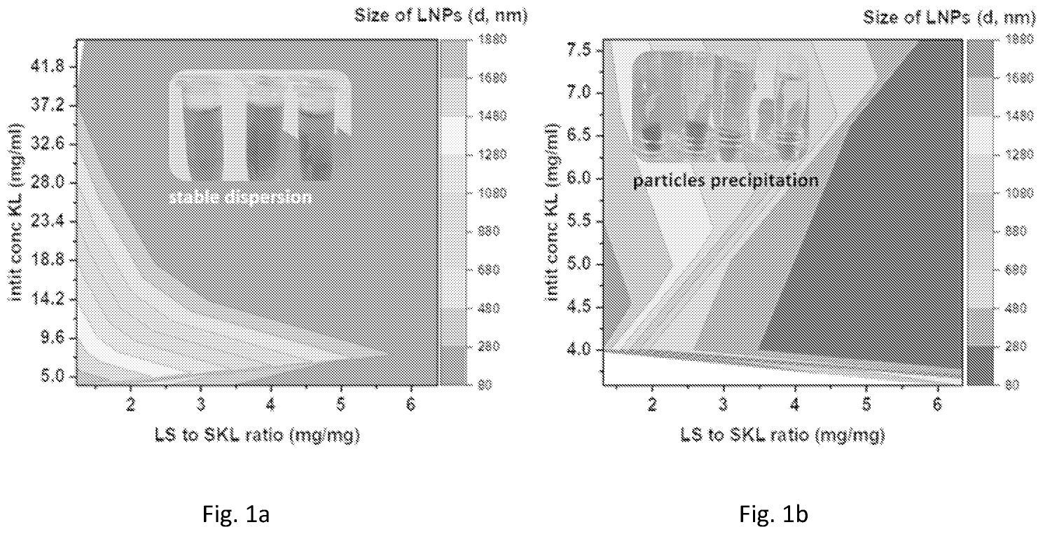

After preliminary experiments proved that the approach works in general, we have tested the concentration range and LS/SKL ratios, where the stable dispersion can be achieved. In this context, dispersions having a colloidal lignin particle (LNP) hydrodynamic diameter of 480 nm or less have been considered to be stable colloidal dispersions, mixtures having an LNP hydrodynamic diameter >690 nm are observed to precipitate, and dispersions having hydrodynamic diameter intermediate these ranges do not exhibit immediate precipitation and may be stable for extended periods. As it is shown in FIG. 1a, the optimal LS to SKL ratio can be found at 5 and above, since at these ratios, all lignin concentrations are stable. However, stable colloid dispersions may also be obtained at low LS/SKL ratio at high overall lignin concentration. Also, at concentrations of LS/SKL below 2% wt (FIG. 1b), the optimal LS/SKL ratio can be lowered to 4.

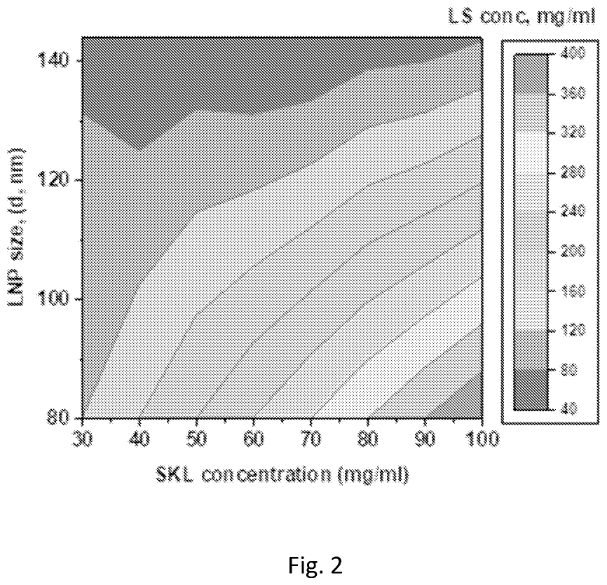

Dispersions with an LNP hydrodynamic diameter below 200 nm can be obtained in a broad concentration range, as is shown in FIG. 2 below. Dispersions may contain up to 10 wt. % of SKL and up to 40% wt. % of LS simultaneously (100 and 400 mg/ml respectively).

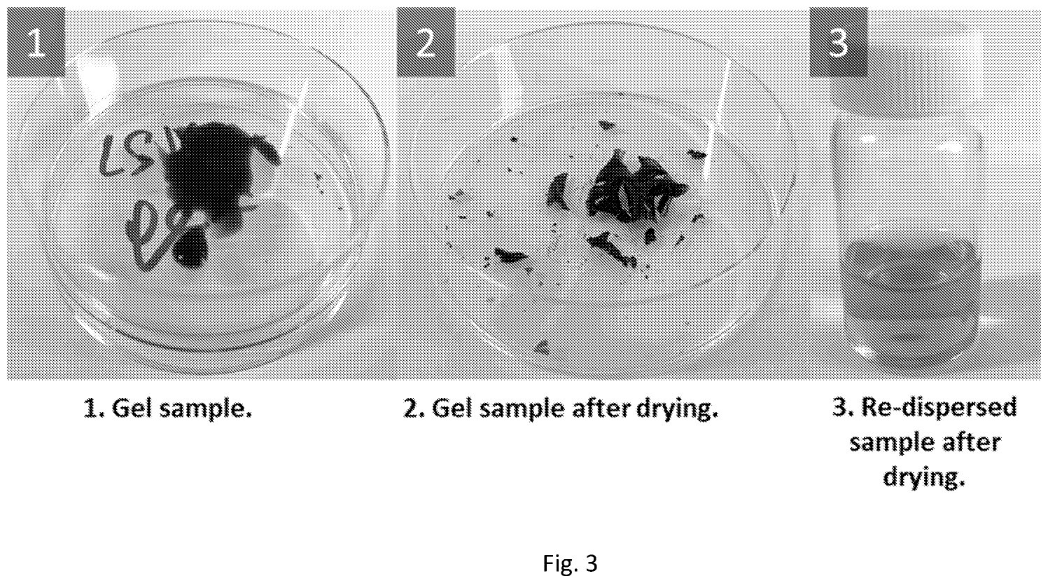

At total concentrations of lignin above 10 wt %, the system forms a gel-like dispersion, which can be re-dispersed or diluted with water. FIG. 3 demonstrates the properties of a dispersion having approximately 15 wt % lignin at a LS/SKL ratio of approximately 5, as well as the effects of drying and redispersion. In the first image it can be seen that the dispersion has a viscous, gel-like structure. Drying of this sample provides a brittle, flakeable solid, as seen in the second image. This dried solid can be re-dispersed in water to provide a homogenous free-flowing dispersion, as shown in the third image.

### Example 2

In the experiments of Example 2, Organosolv lignin from ethanol-water pulping of Beechwood is used as the first lignin. For further details of this lignin see Ago, M. et al., ACS Appl. Mater. Interfaces 2016, 8, 35, 23302-23310. As the second lignin, technical sodium lignosulfonate from Domsjö Fabriker (as in Example 1) or, technical sodium lignosulfonate from Merck (LS Sigma, Sigma-Aldrich, SKU 471038) was used.

Dispersions of lignosulfonate (LS) and Organosolv lignin (OS lignin) were produced by dissolving relevant quantities of the lignins in dilute base (1 M NaOH) and then adjusting the pH of the resulting mixture (using 1 M sulphuric acid) to provide a colloidal dispersion having a final pH somewhere in the range of from 2-8.

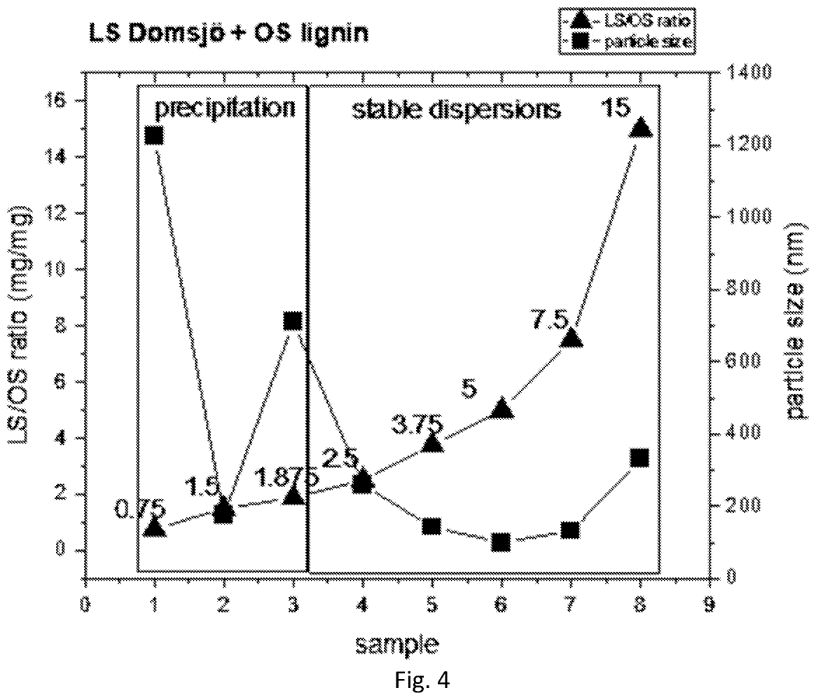

Table 1 and FIG. 4 show the results obtained with mixtures of Organosolv lignin and lignosulfonate from Domsjö.

TABLE 1

| sample | OS lignin conc. | LS DS10 conc. | LS/OS ratio | particle size |
|---|---|---|---|---|
| # | mg/ml | mg/ml | mg/mg | nm |
| 1 | 400 | 300 | 0.75 | 1224 |
| 2 | 200 | 300 | 1.5 | 175 |
| 3 | 160 | 300 | 1.875 | 710 |
| 4 | 120 | 300 | 2.5 | 260 |
| 5 | 80 | 300 | 3.75 | 142 |
| 6 | 60 | 300 | 5 | 100 |
| 7 | 40 | 300 | 7.5 | 132 |
| 8 | 20 | 300 | 15 | 330 |

It can be seen that Domsjö LS when mixed with OS lignin behaves similarly to the mixtures of LS/KL as described in Example 1, and that stable dispersions are obtained at LS/OS ratios of approximately 2.5 and greater.

It was found that a dispersion of Domsjö lignosulfonate and organosolv lignin (19 wt % dispersion, LS:OS weight ratio 2:1) could be dried and re-dispersed after drying, in a similar manner to the LS/KL dispersions of Example 1.

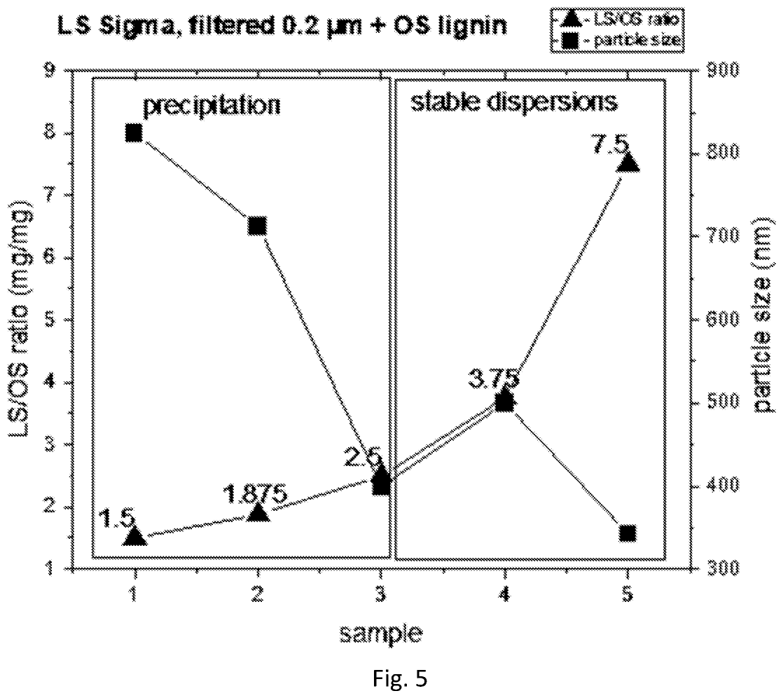

Table 2 and FIG. 5 show the results obtained with mixtures of Organosolv lignin and lignosulfonate from Sigma-Aldrich (Merck).

TABLE 2

| sample | OS lignin conc. | LS Sigma conc. | LS/OS ratio | particle size |
|---|---|---|---|---|
| # | mg/ml | mg/ml | mg/mg | nm |
| 1 | 200 | 300 | 1.5 | 825 |
| 2 | 160 | 300 | 1.875 | 713 |
| 3 | 120 | 300 | 2.5 | 400 |
| 4 | 80 | 300 | 3.75 | 500 |
| 5 | 40 | 300 | 7.5 | 342 |

Dispersions produced using lignosulfonate from Sigma-Aldrich behave similarly to those produced using lignosulfonate from Domsjö, and stable dispersions are obtained at LS/OS ratios of approximately 3.75 and greater. It was however noted that the sample of lignosulfonate from Sigma seemed to contain many impurities. For example, the particles size changed drastically if the lignosulfonate was filtered prior to the experiment. Thus, for consistency of results, the dissolved lignosulfonate was filtered through a 0.2 micron filter prior to forming of the dispersions.

### Example 3

The number-weighted particle diameter and zero-shear viscosity were measured for a series of nanogels produced by the method described in Example 1. The nanogels each have a total lignin concentration of 30 wt % and a LS to SKL ratio of 5:1, but with varying pH in the range of from 4.3 to 9.9. The results are shown in Table 3 below.

TABLE 3

| | Zero-shear viscosity, | Number-weighted particle |
|---|---|---|
| pH | Pa · s | diameter, nm |
| 4.3 | 189 | 44 |
| 5.9 | 107 | 28 |
| 7.5 | 5.62 | 10 |
| 8.7 | 0.42 | ND |
| 9.9 | 0.03 | 122 |

The gelation times for each of these nanogels was each in the range of less than 1 hour. It can be seen that the (zero-shear) viscosity of the gel increases with a decrease in alkalinity.

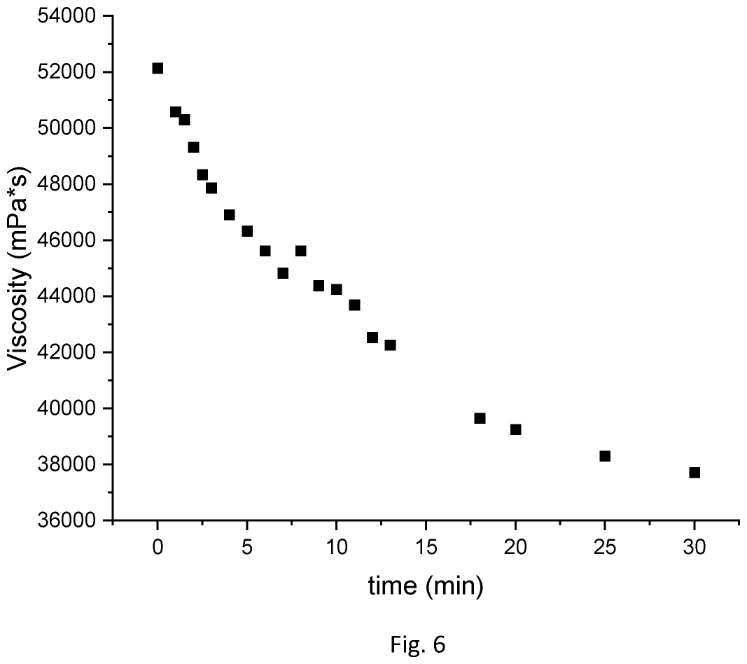

The dynamic viscosity properties of the nanogel prepared as above having a pH of 5.9 was investigated by the method of ASTM D2196-10. The nanogel was stirred with a spindle rotation rate of 6 rpm for 30 minutes, and viscosity was determined at regular intervals. The results are shown in FIG. 6.

It can be seen that the nanogel exhibits considerable shear thinning, the viscosity decreasing from an initial value of in excess of 52 000 mPa·s to value of less than 38 000 mPa·s after 30 minutes at a constant shear rate 6 rpm.

The gel prepared as above having pH 4.3 was subjected to dialysis. The gel was transferred into a dialysis bag having 12-14 kDA MWCO (Spectra/Por, Sigma Aldrich) and dialyzed against deionized water until reaching pH 6. The gel maintained colloidal stability after dialysis and the dialysate remained colourless, indicating that no significant leaching of lignin occurred across the dialysis membrane.

1. A colloidal dispersion comprising a first lignin, a second lignin and an aqueous liquid continuous phase,
wherein the colloidal dispersion has a dispersion pH,
wherein the first lignin is a lignin that in absence of the second lignin would be essentially insoluble in the aqueous continuous phase at the dispersion pH,
wherein the second lignin is a lignin that in absence of the first lignin would be soluble in the aqueous continuous phase at the dispersion pH, and
wherein the colloidal dispersion is a system in which colloidal lignin nanoparticles comprising the first lignin and the second lignin are dispersed in the aqueous liquid continuous phase.

2. The colloidal dispersion according to claim 1, wherein the dispersion pH is a pH of from about pH 1 to about pH 10, such as a dispersion pH of from about pH 3 to about pH 8, such as a dispersion pH of from about pH 5 to about pH 7.

3. The colloidal dispersion according to claim 1, wherein the aqueous continuous phase comprises greater than 80 vol % water, such as greater than 90 vol % water, such as greater than 95 vol % water.

4. The colloidal dispersion according to claim 1, wherein the mass ratio of the second lignin to the first lignin is from about 1:90 to about 90:1, such as from about 3:1 to about 10:1, such as from about 4:1 to about 5:1.

5. The colloidal dispersion according to claim 1, wherein the colloidal dispersion has a concentration of from about 0.1 wt % to about 80 wt %, such as from about 5 wt % to about 50 wt %, such as from about 10 wt % to about 40 wt %, calculated as the combined total weight of the first and second lignin relative to the total weight of the colloidal dispersion.

6. The colloidal dispersion according to claim 1, wherein the first lignin is selected from kraft lignin, soda lignin, organosolv lignin, native lignin, salts thereof, and combinations thereof.

7. The colloidal dispersion according to claim 1, wherein the second lignin is an anionic lignin, preferably selected from lignosulfonate, sulfonate-derivatised lignin, carboxylate-derivatised lignin, oxidized lignin, lignin-polymer grafts, non-covalent lignin-polymer conjugates, salts thereof, and combinations thereof.

8. The colloidal dispersion according to claim 1, wherein the second lignin is a cationic lignin, preferably selected from a cationic primary amine, secondary amine, tertiary amine, or quaternary ammonium-derivatised lignin, or salts thereof.

9. The colloidal dispersion according to claim 1, comprising spent pulping liquor from a kraft-, soda-, organosolv and/or a sulfite-pulping process.

10. The colloidal dispersion according to claim 1, wherein the colloidal dispersion is a nanogel.

11. The colloidal dispersion according to claim 10, wherein the nanogel is thixotropic.

12. A dispersible concentrate obtainable by dewatering of a colloidal dispersion according to claim 1, preferably to a total dry matter content of less than 95 wt %, such as to a total dry matter content of less than 90 wt %, such as to total dry matter content of less than 80 wt %.

13. A lignin-containing product comprising a colloidal dispersion according to claim 1, and/or a dispersible concentrate.

14. Use of a colloidal dispersion according to claim 1, and/or a dispersible concentrate in the manufacture of a lignin-containing product.
